(19) United States
(12) Patent Application Publication
(10) Pub. No.: US 2021/0096485 A1
(43) Pub. Date: Apr. 1, 2021

(54) TRANSFER DEVICE AND IMAGE FORMING APPARATUS

(71) Applicant: Konica Minolta, Inc., Tokyo (JP)

(72) Inventor: Taro TAKECHI, Saitama (JP)

(21) Appl. No.: 17/011,706

(22) Filed: Sep. 3, 2020

(30) Foreign Application Priority Data
Sep. 26, 2019 (JP) 2019-175496

(51) Int. Cl. G03G 15/16; B65H 5/06

(52) U.S. Cl. CPC G03G 15/1605; B65H 5/062

(57) ABSTRACT

A transfer device includes a plurality of pressing members capable of pressing an image carrier, a contact position changing section that changes a contact position between the image carrier and a transfer roller in a rotational direction of the image carrier in accordance with a type of a recording medium on which an image is formed, and a contact pressure changing section that changes a contact pressure between the image carrier and the transfer roller by changing the number of the pressing member that presses the image carrier according to the contact position.

### CROSS REFERENCE TO RELATED APPLICATIONS

The entire disclosure of Japanese Patent Application No. 2019-175496 filed on Sep. 26, 2019 is incorporated herein by reference in its entirety.

### BACKGROUND

### Technological Field

The present invention relates to a transfer device and an image forming apparatus.

### Description of Related Art

Conventionally, image forming apparatuses having an intermediate transfer system are commonly used. The intermediate transfer system primarily transfers a toner image formed on a photoconductor (an image carrier) to an intermediate transfer belt (an image carrier and an intermediate transfer member) and secondarily transfers the toner image on the intermediate transfer belt to a sheet.

O O O 1 Such an image forming apparatus has a risk of making image defects due to discharge between the photoconductor and a primary transfer roller that are placed facing each other through the intermediate transfer belt. Examples of image defects are white spots and wavy color unevenness (ripples). White spots occur when toner loses electric charge due to discharge and fails to be transferred. Ripples occur when the polarity of electric charges of toner is reversed due to discharge and the toner is collected at downstream of a primary transfer section.

In order to prevent such image defects, the primary transfer roller is usually placed on a downstream side in a moving direction of the intermediate transfer belt so as to be shifted from the photoconductor in the image forming apparatus. In such an arrangement, primary transfer roller 422 presses intermediate transfer belt 421 by a predetermined pressing force, as illustrated in FIG. 1A, and intermediate transfer belt 421 is pressed onto photoconductor drum 413. This forms primary transfer nip section N1.

In recent years, incidentally, there has been a demand for such an image forming apparatus to form images on a sheet having ruggedness formed on its surface such as embossed paper and rough paper (rugged paper). However, it is known that rugged paper is difficult for toner to reach recessed parts during secondary transfer and a secondary transfer performance is deteriorated compared with that for normal paper.

In view of this, a technique for improving the secondary transfer performance for the recessed parts on rugged paper has been proposed. The technique includes weakening the pressing force of the primary transfer roller against the intermediate transfer belt from usual at the time of forming an image on rugged paper. This makes toner on the intermediate transfer belt easier to peel off from the belt, and improves the secondary transfer performance accordingly (see, for example, Japanese Patent Application Laid-Open No. 2010-139955).

There arises a problem, however, that the primary transfer performance is remarkably degraded in the above-mentioned arrangement in which the primary transfer roller is placed on the downstream side in the moving direction of the intermediate transfer belt so as to be shifted from the photoconductor. The problem is caused by failing to form primary transfer nip section N1 when the pressing force of the primary transfer roller is weakened and thus primary transfer roller 422 is pushed back by the tension of intermediate transfer belt 421 as illustrated in FIG. 1B

### SUMMARY

An object of the present invention is to provide a transfer device and an image forming apparatus capable of maintaining a favorable transfer performance regardless of a type of a sheet in an image forming apparatus having an intermediate transfer system.

To achieve at least one of the above-mentioned objects, according to an aspect of the present invention, a transfer device reflecting one aspect of the present invention is a device, including:

a plurality of pressing members capable of pressing an image carrier;

a contact position changing section that changes a contact position between the image carrier and a transfer roller in a rotational direction of the image carrier according to a type of a recording medium on which an image is formed; and

a contact pressure changing section that changes a contact pressure between the image carrier and the transfer roller by changing the number of the pressing member that presses the image carrier according to the contact position.

To achieve at least one of the above-mentioned objects, according to an aspect of the present invention, an image forming apparatus reflecting one aspect of the present invention is an apparatus including the transfer device.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIGS. 1A and 1B are diagrams explaining a conventional problem in an image forming apparatus having an intermediate transfer system;

FIG. 2 is a diagram illustrating a schematic configuration of an image forming apparatus in an embodiment of the present invention;

FIG. 3 is a block diagram indicating a main functional configuration of the image forming apparatus in the embodiment of the present invention;

FIG. 4A is a diagram illustrating first nip positions and nip pressure in the embodiment of the present invention, FIG. 4B is a diagram illustrating a problem when the nip pressure is weakened from a state of FIG. 4A, and FIG. 4C is a diagram illustrating second nip positions and the nip pressure in the embodiment of the present invention;

FIG. 5 is a partially cutout perspective view explaining an overall outline of an intermediate transfer unit in the embodiment of the present invention;

FIG. 6 is a plan view illustrating a configuration for vertically moving a movable side plate in the intermediate transfer unit, and indicates a state that the movable side plate is pushed up;

FIG. 7 is a plan view illustrating a configuration for moving a primary transfer roller by pressing its shaft, and indicates a state that the primary transfer roller is in the first nip position illustrated in FIG. 4A;

FIG. 8 is a perspective view illustrating a configuration for pressing and moving the shaft of primary transfer roller; and

FIG. 9 is a side view explaining an operation when the position of the primary transfer roller is switched between the first nip position and a second nip positions.

### DETAILED DESCRIPTION OF EMBODIMENTS

Hereinafter, one or more embodiments of the present invention will be described with reference to the drawings. However, the scope of the invention is not limited to the disclosed embodiments.

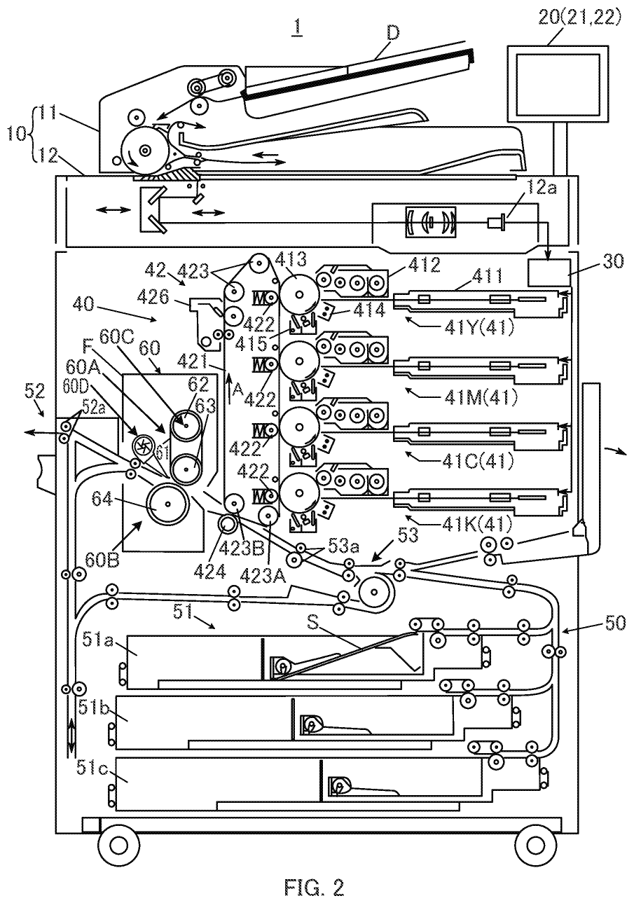

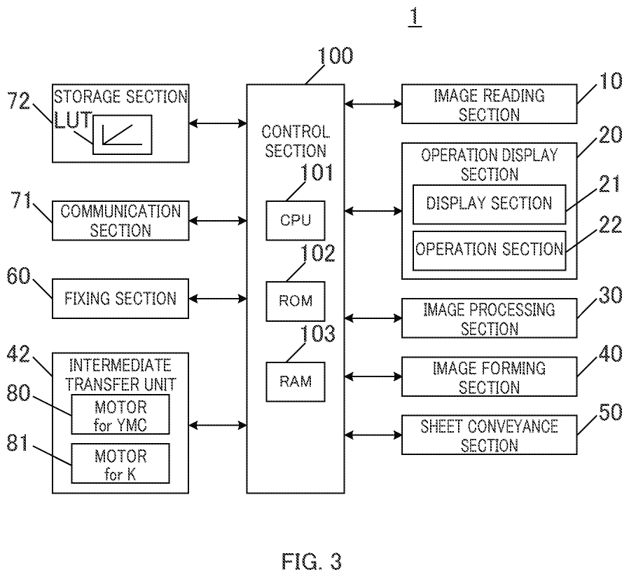

FIG. 2 is a diagram schematically illustrating an entire configuration of image forming apparatus 1 in the embodiment of the present invention. FIG. 3 indicates a main section of a control system of image forming apparatus 1 in the present embodiment.

Image forming apparatus 1 is a color image forming apparatus having an intermediate transfer system with electrophotographic process technology. That is, image forming apparatus 1 primarily transfers toner images of yellow (Y), magenta (M), cyan (C), and black (K) formed on photoconductor drums 413 to intermediate transfer belt 421, and superimposes the toner images of the four colors on one another on intermediate transfer belt 421. Then, image forming apparatus 1 secondarily transfers the resultant image to a sheet, thereby forming a toner image.

A longitudinal tandem system is adopted for image forming apparatus 1. In the longitudinal tandem system, respective photoconductor drums 413 corresponding to the four colors of YMCK are placed in series in the travelling direction (vertical direction) of intermediate transfer belt 421, and the toner images of the four colors are sequentially transferred to intermediate transfer belt 421 in one cycle.

As illustrated in FIG. 3, image forming apparatus 1 includes image reading section 10, operation display section 20, image processing section 30, image forming section 40, sheet conveyance section 50, fixing section 60, control section 100, and the like.

Control section 100 includes central processing unit (CPU) 101, read only memory (ROM) 102, random access memory (RAM) 103 and the like. CPU 101 reads a program suited to processing contents out of ROM 102, develops the program in RAM 103, and integrally controls an operation of each block of image forming apparatus 1 in cooperation with the developed program. At this time, CPU 101 refers to various kinds of data stored in storage section 72. Storage section 72 is composed of, for example, a non-volatile semiconductor memory (so-called flash memory) or a hard disk drive.

Control section 100 transmits and receives various data to and from an external apparatus (for example, a personal computer) connected to a communication network such as a local area network (LAN) or a wide area network (WAN), through communication section 71. Control section 100 receives, for example, image data transmitted from the external apparatus, and performs control to form a toner image on sheet on the basis of the image data (input image data). Communication section 71 is composed of, for example, a communication control card such as a LAN card.

Image reading section 10 includes auto document feeder (ADF) 11, document image scanning device 12 (a scanner), and the like.

Auto document feeder 11 causes a conveyance mechanism to feed document D placed on a document tray, and sends out document D to document image scanner 12. Auto document feeder 11 can successively read images (even both sides thereof) of a large number of documents D placed on the document tray at once.

Document image scanner 12 optically scans a document fed from auto document feeder 11 to its contact glass or a document placed on its contact glass, and brings light reflected from the document into an image on the light receiving surface of charge coupled device (CCD) sensor 12a, to thereby read the document image. Image reading section 10 generates input image data on the basis of a reading result provided by document image scanner 12. Image processing section 30 performs predetermined image processing on the input image data.

Operation display section 20 includes, for example, a liquid crystal display (LCD) with a touch panel, and functions as display section 21 and operation section 22. Display section 21 displays various operation screens, image conditions, operating statuses of functions, and the like in accordance with display control signals received from control section 100. Operation section 22 includes various operation keys such as numeric keys and a start key, receives various input operations performed by a user, and outputs operation signals to control section 100.

Image processing section 30 includes a circuit that performs a digital image process suited to initial settings or user settings on the input image data, and the like. For example, image processing section 30 performs tone correction on the basis of tone correction data (tone correction table LUT) stored in storage section 72, under the control of control section 100. In addition to the tone correction, image processing section 30 also performs various correction processes such as color correction and shading correction as well as a compression process, on the input image data. Image forming section 40 is controlled on the basis of the image data that has been subjected to these processes.

Image forming section 40 includes image forming units 41Y, 41M, 41C, and 41K that form images of colored toners of a Y component, an M component, a C component, and a K component on the basis of the input image data, intermediate transfer unit 42, and the like.

Image forming units 41Y, 41M, 41C, and 41K for the Y component, the M component, the C component, and the K component have similar configurations. For ease of illustration and description, common elements are denoted by the same reference signs. Only when elements need to be discriminated from one another, Y, M, C, or K is added to their reference signs. In FIG. 2, reference signs are given to only the elements of image forming unit 41Y for the Y component, and reference signs are omitted for the elements of the other image forming units 41M, 41C, and 41K.

Image forming unit 41 includes exposing device 411, developing device 412, photoconductor drum 413, charging device 414, drum cleaning device 415 and the like.

Photoconductor drum 413 is a negatively charged organic photoconductor (OPC) sequentially laminating an undercoat layer (UCL), a charge generation layer (CGL), and a charge transport layer (CTL) on the peripheral surface of a conductive cylinder (an aluminum tube) made of aluminum, for example. The charge generation layer is composed of an organic semiconductor in which a charge generating material (e.g., a phthalocyanine pigment) is dispersed in a resin binder (e.g., polycarbonate), and generates a pair of positive charges and negative charges by light exposure from exposing device 411. The charge transport layer is composed of a hole transport material (an electron-donating nitrogen-containing compound) dispersed in a resin binder (e.g., a polycarbonate resin), and transports positive charges generated in the charge generation layer to the surface of the charge transport layer.

Control section 100 controls a driving current supplied to a driving motor (not shown in the drawings) that rotates photoconductor drums 413, whereby photoconductor drums 413 are rotated at a constant circumferential speed (linear speed).

Charging device 414 evenly and negatively charges the surface of photoconductor drum 413 having photoconductivity. Exposing device 411 is composed of, for example, a semiconductor laser, and irradiates photoconductor drum 413 with laser light in accordance with an image of each color component. The surface charges (negative charges) of photoconductor drum 413 are neutralized by the positive charges generated in the charge generation layer of photoconductor drum 413 and transported to the surface of the charge transport layer. An electrostatic latent image of each color component is formed on the surface of photoconductor drum 413 by the potential difference from the surroundings.

Developing device 412 is, for example, a developing device of a two-component reverse type, and attaches toners of respective color components to the surface of photoconductor drums 413, and visualizes the electrostatic latent image to form a toner image.

Drum cleaning device 415 includes a drum cleaning blade (hereinafter, simply referred to as a cleaning blade) 416 and the like as a cleaning member sliding on the surface of photoconductor drums 413. Drum cleaning device 415 removes transfer residual toner that remains on the surface of photoconductor drums 413 with cleaning blade 416 after primary transfer.

Intermediate transfer unit 42 includes intermediate transfer belt 421 as an image carrier, primary transfer rollers 422, a plurality of support rollers 423, secondary transfer roller 424, belt cleaning device 426, and the like.

Intermediate transfer belt 421 is composed of an endless belt, and is stretched around the plurality of support rollers 423 in a loop form. At least one of the plurality of support rollers 423 is composed of a driving roller, and the others are each composed of a driven roller. Preferably, for example, roller 423A placed on the downstream side in the belt travelling direction relative to primary transfer rollers 422 for K-component is a driving roller. With this configuration, the travelling speed of the belt at a primary transfer section can be easily maintained at a constant speed. When driving roller 423A rotates, intermediate transfer belt 421 travels in arrow A direction at a constant speed.

Primary transfer rollers 422 are placed on the inner periphery side of intermediate transfer belt 421 to face photoconductor drums 413 of respective color components. Primary transfer rollers 422 are brought into pressure contact with photoconductor drums 413 with intermediate transfer belt 421 therebetween, whereby a primary transfer nip for transferring a toner image from photoconductor drums 413 to intermediate transfer belt 421 is formed.

Secondary transfer roller 424 is placed at a position on the outer peripheral surface side of intermediate transfer belt 421 so as to face backup roller 423B placed on the downstream side in the belt travelling direction relative to driving roller 423A. Secondary transfer roller 424 is brought into pressure contact with backup roller 423B with intermediate transfer belt 421 therebetween, whereby a secondary transfer nip for transferring a toner image from intermediate transfer belt 421 to sheet S is formed.

When intermediate transfer belt 421 passes through the primary transfer nip, the toner images on photoconductor drums 413 are primarily transferred to intermediate transfer belt 421 sequentially. To be more specific, a primary transfer bias is applied to primary transfer rollers 422, and an electric charge of the polarity opposite to the polarity of the toner is applied to the rear side of intermediate transfer belt 421 (the side that makes contact with primary transfer rollers 422) whereby the toner image is electrostatically transferred to intermediate transfer belt 421.

Thereafter, when the sheet passes through the secondary transfer nip, the toner image on intermediate transfer belt 421 is secondarily transferred to the sheet. To be more specific, a secondary transfer bias is applied to secondary transfer roller 424, and an electric charge of the polarity opposite to the polarity of the toner is applied to the rear surface side of the sheet (the side that makes contact with secondary transfer roller 424) whereby the toner image is electrostatically transferred to the sheet, and the sheet is conveyed toward fixing section 60.

Belt cleaning device 426 has a belt cleaning blade and the like which is brought into sliding contact with the surface of the intermediate transfer belt 421, and removes transfer residual toner remaining on the surface of the intermediate transfer belt 421 after the secondary transfer. A configuration (so-called a belt-type secondary transfer unit) in which a secondary transfer belt is installed in a stretched state in a loop form around a plurality of support rollers including a secondary transfer roller may also be adopted in place of secondary transfer roller 424.

Fixing section 60 includes upper fixing section 60A having fixing side members placed on a fixing surface side (a side of the surface on which a toner image is formed) of the sheet, lower fixing section 60B having a back side supporting member placed on the rear surface side (a side of the surface opposite to the fixing surface) of the sheet, heating source 60C, and the like. The back side supporting member is brought into pressure contact with the fixing side members, whereby a fixing nip for conveying the sheet in a tightly sandwiching manner is formed.

Upper fixing section 60A includes endless fixing belt 61, heating roller 62, and upper pressure roller 63, all of which are fixing side members (a belt heating system). Fixing belt 61 is stretched around heating roller 62 and upper pressure roller 63 with a predetermined belt tension (e.g., 400 N).

Heating roller 62 is configured to heat fixing belt 61. Heating roller 62 includes heating source 60C that heats fixing belt 61. Heating roller 62 is, for example, a halogen heater having a configuration that outer peripheral surface of a cylindrical core metal formed of aluminum or the like is coated with a resin layer of PTFE.

Lower fixing section 60B includes, for example, lower pressure roller 64, which is a back side supporting member (a roller pressurization system). Lower pressure roller 64 is formed by coating an outer peripheral surface of a base material layer formed of polyimide (PI) with heat-resistant silicone rubber as an elastic layer, and further coating the outer peripheral surface of the elastic layer with a resin layer of a PFA tube as a surface release layer.

At the fixing nip, fixing section 60 applies heat and pressure to the sheet on which a toner image has been secondarily transferred to fix the toner image on the sheet. Fixing section 60 is placed as a unit in fixing part F. In addition, fixing part F is provided with an air-separating unit that blows air to separate sheet S from the fixing side member.

Sheet conveyance section 50 includes sheet feeding section 51, sheet ejection section 52, conveyance path section 53 and the like. Three sheet feed tray units 51a to 51c included in sheet feeding section 51 store sheets S (standard sheets, special sheets) discriminated on the basis of the basis weight (rigidity), the size, and the like, for each type set in advance. Conveyance path section 53 includes a plurality of conveyance rollers such as a pair of registration rollers 53a, and a double-side conveyance path, and the like.

Sheets S stored in sheet tray units 51a to 51c are output one by one from the uppermost, and conveyed to image forming section 40 by conveyance path section 53. At this time, the registration roller section in which the pair of registration rollers 53a are arranged corrects skew of sheet S fed thereto, and the conveyance timing is adjusted. Then, in image forming section 40, the toner image on intermediate transfer belt 421 is secondarily transferred to one side of sheet S at one time, and a fixing process is performed in fixing section 60. Sheet S on which an image has been formed is ejected out of the image forming apparatus by sheet ejection section 52 including sheet ejection rollers 52a.

Incidentally, there is a demand for image forming apparatus 1 having such an intermediate transfer system to form images on paper having ruggedness formed on its surface (embossed paper, rough paper, and the like, hereinafter collectively referred to as “rugged paper”) as sheet S. In many cases, however, rugged paper is difficult for toner to reach recessed parts during the secondary transfer and the secondary transfer performance is deteriorated compared with the transfer performance for normal paper.

In view of this, a technique for improving the secondary transfer performance for the recessed parts on rugged paper has been proposed. The technique includes weakening the pressing force of primary transfer rollers 422 against intermediate transfer belt 421 from usual at the time of forming an image on rugged paper. This makes toner on intermediate transfer belt 421 easier to peel off from intermediate transfer belt 421, and improves the secondary transfer performance accordingly.

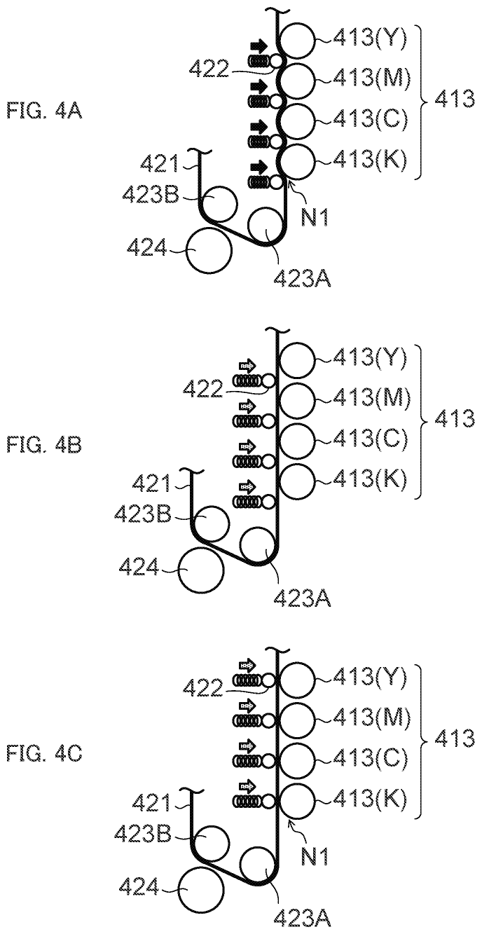

Here, FIG. 4A illustrates positions and pressing conditions of primary transfer nip sections N1 when images are formed on a normal sheet S in a slightly exaggerated manner. As illustrated in FIG. 4A, primary transfer rollers 422 are placed on a downstream side in a moving direction of intermediate transfer belt 421 so as to be shifted from corresponding photoconductor drums 413 from a viewpoint of preventing the above-mentioned image defects such as white spots and ripples as much as possible.

Further, black arrows in FIG. 4A indicate pressing force (nip pressure or contact pressure) toward respective primary transfer rollers 422 by pressing members (coiled springs in this example). In a setting example illustrated in FIG. 4A, each primary transfer roller 422 is pressed with enough pressing force (the nip pressure) to hold primary transfer nip sections N1. This setting enables to secure both the primary transfer performance and the secondary transfer performance of a toner image to normal paper.

The setting of primary transfer nip sections N1 as illustrated in FIG. 4A, however, strengthen adhesion of the primarily transferred toner image to intermediate transfer belt 421, thereby degrading the secondary transfer performance of the toner image to rugged paper at a secondary transfer nip between intermediate transfer belt 421 and secondary transfer roller 424 when rugged paper is used.

In order to solve such a problem, it is conceivable to weaken the pressing force (the contact pressure) of primary transfer rollers 422 against intermediate transfer belt 421 from usual as illustrated in FIG. 4B. Note that dot-filled arrows in FIG. 4B indicate the pressing force to respective primary transfer rollers 422 energized (pressed) by coiled springs, which is a weaker contact pressure than the setting example in FIG. 4A, and arrows in FIG. 4C to be described later indicate the same. The setting of primary transfer nip sections N1 illustrated in FIG. 4B allows toner on intermediate transfer belt 421 to easily peel off from intermediate transfer belt 421.

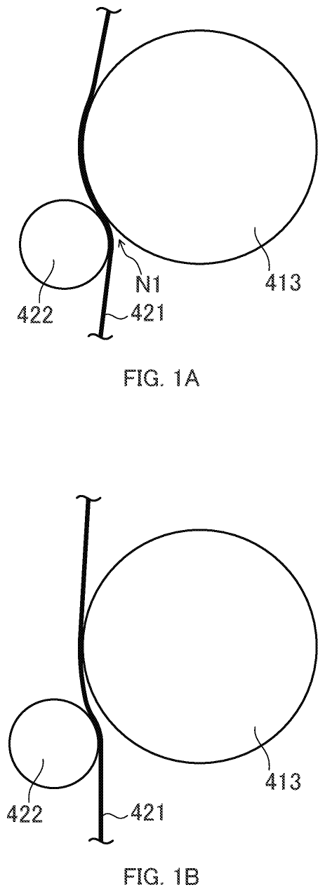

Weakening the pressing force of primary transfer rollers 422 in this manner, however, causes primary transfer rollers 422 to be pushed back by the tension of intermediate transfer belt 421 in the arrangement in which primary transfer rollers 422 placed on the downstream side in the moving direction of intermediate transfer belt 421 so as to be shifted from respective photoconductor drums 413, and thus, no primary transfer nip section N1 is formed as illustrated in FIGS. 1B and 4B. This case arises a problem of remarkably degrading the primary transfer performance from photoconductor drums 413 to intermediate transfer belt 421 although the secondary transfer performance from intermediate transfer belt 421 to rugged paper is secured.

To solve this problem, the position of each primary transfer roller 422 needs to be lifted, as illustrated in FIG. 4C, in order to weaken the pressing force of primary transfer rollers 422 against intermediate transfer belt 421 and to maintain the adhesion with photoconductor drums 413 through primary transfer nip sections N1, namely intermediate transfer belt 421.

Thus, the inventors have found from experiments that the setting of primary transfer nip sections N1 as illustrated in FIG. 4C made it possible to secure both the primary transfer performance and the secondary transfer performance to rugged paper, and furthermore, to print without conspicuous white spots and ripples described above. It has been reaffirmed, however, that the setting of primary transfer nip sections N1 as illustrated in FIG. 4C caused normal paper to have noticeable image defects such as white spots and ripples, and thus, it was insufficient for the use.

Therefore, intermediate transfer unit 42 in the present embodiment is provided with a moving mechanism for each primary transfer roller 422 to reciprocate between a first nip position (a normal position or an initial position) illustrated in FIG. 4A for forming an image on normal paper and a second nip position (an upper position) illustrated in FIG. 4C for forming an image on rugged paper.

In accordance with the present invention, the moving mechanism and control section 100 correspond to “contact position changing section” that changes a contact position between image carriers (intermediate transfer belt 421 and photoconductor drums 413) and primary transfer rollers 422 in a rotational directions of intermediate transfer belt 421 (the image carrier) according to a type of sheet S (a recording medium) on which images are formed.

Hereinafter, an outline and a specific configuration of the moving mechanism (the contact position changing section) in intermediate transfer unit 42 of the present embodiment will be described in detail.

In the present embodiment, four primary transfer rollers 422 facing respective photoconductor drums 413 of YMCK are configured to (collectively) move at a time. To achieve this configuration, shafts of primary transfer rollers 422 are held by a group of members (a pair of side plates in the following examples) and the side plates are configured to be movable with respect to intermediate transfer unit 42. Hereinafter, the side plates are referred to as “movable side plates” for convenience of explanation.

Furthermore, since colored toners of YMC are not used for monochrome printing (monochrome printing of K toner in this example), three primary transfer rollers 422 facing respective photoconductor drums 413 of Y, M, and C configured to be retractable at the time of monochrome printing.

In view of the above, the present embodiment has the following configuration.

A plurality of support rollers 423 (see FIG. 2), on which intermediate transfer belt 421 is suspended, are rotatably supported by a pair of side plates (hereinafter, referred to as “fixed side plates” for convenience of explanation) such as frames fixed to the main body of image forming apparatus 1.

In the meantime, each primary transfer roller 422 (see FIG. 2) is attached to side plates movable relative to the fixed side plates, which are “movable side plates” as mentioned above. In a configuration example described later, a pair of movable side plates is respectively placed on the inner surface side of a pair of the fixed side plates, which are located approximately in parallel one side to the other, so that the movable side plates can move approximately in a vertical direction.

Thus, the above-described configuration provides a foundation of the moving mechanism (the contact position changing section) that reciprocates primary transfer rollers 422 between the first nip position (the normal position or the initial position) illustrated in FIG. 4A for forming an image on normal paper and the second nip position (the upper position) illustrated in FIG. 4C for forming an image on rugged paper.

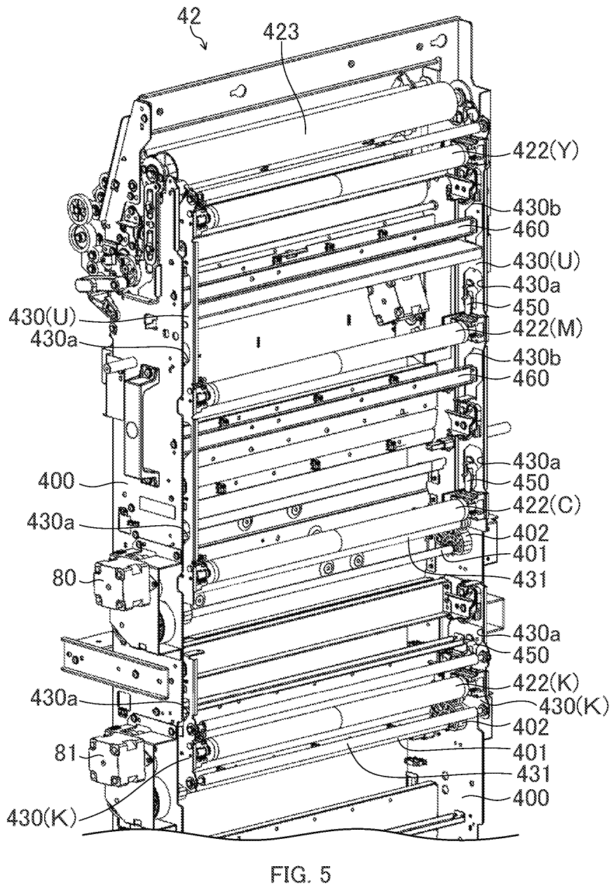

Next, further details of the moving mechanism (the contact position changing section) will be described with reference to FIGS. 5 to 9.

FIG. 5 is a perspective view illustrating an extracted main part of intermediate transfer unit 42 of image forming apparatus 1 in the present embodiment. Note that intermediate transfer belt 421 is not illustrated in FIG. 5 in order to facilitate understanding. Control section 100 and intermediate transfer unit 42 correspond to “transfer device” in the present embodiment.

Referring to FIG. 5, in intermediate transfer unit 42 of the present embodiment, movable side plates 430 are movably attached to the respective inner sides of the pair of fixed side plates 400 placed on both sides of image forming apparatus 1 in a front depth direction.

Among them, fixed side plates 400 and 400 are placed approximately in parallel to each other at a distance slightly wider than the length of the width direction of intermediate transfer belt 421. Then, a plurality of long connecting members 460 is provided in parallel with primary transfer rollers 422 and the like at the inner surface of fixed side plates 400 and 400, as illustrated in FIG. 5, in order to connect both sides of fixed side plates 400 together and maintain (fix) such a parallel state. Note that other functions of connecting members 460 will be described later.

Fixed side plates 400 and 400 are detachably fixed to the main body of image forming apparatus 1, and have roles of rotatably holding intermediate transfer belt 421, slidably holding movable side plates 430, and the like. That is, as described above, fixed side plates 400 rotatably shaft-support a plurality of support rollers 423, which rotatably support intermediate transfer belt 421 (see FIG. 2 as appropriate).

Meanwhile, movable side plates 430 rotatably hold four primary transfer rollers 422 respectively facing to photoconductor drums 413 that carry toner images of respective four colors (i.e., Y, M, C, and K).

In the present embodiment, the outer surfaces of movable side plates 430 respectively contact with the inner surfaces of the pair of fixed side plates 400, and the position of movable side plates 430 relative to fixed side plates 400 is changed, i.e., movable side plates 430 slide and move. This enables to adjust the positions of primary transfer rollers 422 relative to photoconductor drums 413 and the like.

Further, in the present embodiment, intermediate transfer unit 42 has movable side plates 430 (U) and movable side plates 430 (K) separately. Movable side plates 430 (U) rotatably hold primary transfer rollers 422 (Y), 422 (M), and 422 (C), which form primary transfer nip sections N1 for respective images of YMC (three colors). Movable side plates 430 (K) rotatably hold primary transfer roller 422 (K), which forms primary transfer nip section N1 for an image of K (black).

That is, in the present embodiment, primary transfer rollers 422 (Y), 422 (M), and 422 (C) move integrally with a moving operation of movable side plates 430 (U), and primary transfer roller 422 (K) moves with a moving operation of movable side plates 430 (K).

In relation to the present invention, movable side plates 430 (K) correspond to “first movable side plates” that hold a shaft of transfer roller 422 (K) transferring black images, and movable side plates 430 (U) correspond to “second movable side plates” that hold shafts of transfer rollers 422 (Y) to (M) transferring images of respective colors other than black.

Such a configuration mainly intends to move movable side plates 430 (U) to retract (release the contact pressure from) primary transfer rollers 422 respectively facing photoconductor drums 413 of Y, M, and C at the time of monochrome printing. The detail of the configuration will be described later.

As illustrated in FIG. 5, motors 80 and 81 are provided on the outer side of fixed side plates 400 on the front side of the apparatus, and work as driving sources for moving movable side plates 430 in the vertical direction (see FIG. 3 as appropriate).

Out of these two, the upper motor 80 is a driving source for moving a pair of the movable side plates 430 (U) in the vertical direction. The pair of movable side plates 430 (U) holds primary transfer rollers 422 (Y), 422 (M), and 422 (C) primarily transferring toner images of respective colors (Y, M, or C), which are respectively carried by three photoconductor drums 413 from the top of the apparatus, onto intermediate transfer belt 421.

The lower motor 81, on the other hand, is a driving source for moving a pair of the movable side plates 430 (K) in the vertical direction. The pair of movable side plates 430 (K) holds primary transfer roller 422 (K) primarily transferring a toner image of K (black), which is carried by the lowest photoconductor drum 413 in the apparatus, onto intermediate transfer belt 421.

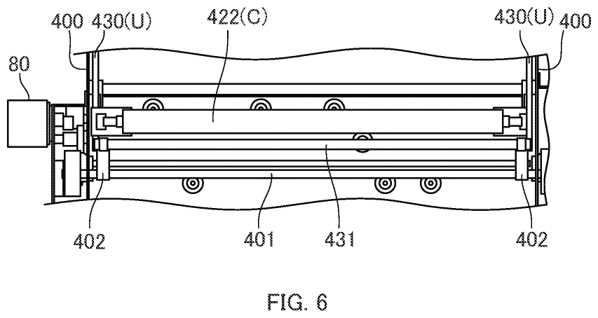

Here, FIG. 6 is a plan view for explaining a mechanism for moving movable side plates 430 (U) in the vertical direction, and indicates a state that movable side plates 430 (U) are pushed upward (see FIG. 4C as appropriate).

As illustrated in FIG. 6, fixed side plates 400 rotatably shaft-support cam shaft 401 including a pair of eccentric cams 402 and 402. Meanwhile, movable side plates 430(U) include cam receiving shaft 431 pressed by such eccentric cams 402. Note that cam receiving shaft 431 also has functions of connecting the pair of movable side plates 430U and 430U together with other shaft members (not shown) and maintaining the positional relation (a parallel state).

Thus, in the present embodiment, motor 80 is rotated in a predetermined direction under the control of control section 100, the driving force is transmitted to cam shaft 401 through a plurality of gears (see FIG. 6), and thus cam shaft 401 and eccentric cams 402 are rotated in the predetermined direction. At this time, each tip of the pair of eccentric cams 402 and 402 to rotate pushes cam receiving shaft 431 upward, thereby integrally lifting movable side plates 430 (U) together with cam receiving shaft 431 (see FIGS. 5 and 6).

Further, referring to the state illustrated in FIG. 6, motor 80 is rotated in an opposite direction to the above under the control of control section 100, the driving force is transmitted to cam shaft 401 through the gears, and thus cam shaft 401 and eccentric cams 402 are rotated in the opposite direction to the above. At this time, each tip of eccentric cams 402 and 402 to rotate moves downward away from cam receiving shaft 431. This releases cam receiving shaft 431 and movable side plates 430 (U) from the pressing state described above, and thus receiving shaft 431 and movable side plates 430 (U) are integrally lowered by their own weight.

Incidentally, since the same mechanism described above is applied for moving the lower movable side plates 430 (K) in the vertical direction by the driving of motor 81 (see FIG. 5 as appropriate), a detailed description thereof will be omitted.

In the present embodiment as described above, motors 80 and 81 rotate under the control of control section 100, and thereby movable side plates 430 (U) and 430 (K) move in the vertical direction relative to fixed side plates 400.

The vertical movement makes it possible to adjust the position of primary transfer nip section N1 between each primary transfer roller 422 held by movable side plates 430 and a corresponding photoconductor drum 413 via intermediate transfer belt 421. That is, when movable side plates 430 (U) and 430 (K) move upward, nip positions also move upward, which is an upstream side of a conveying direction (see FIG. 4C), and when movable side plates 430 (U) and (K) move downward, the nip positions also move downward, which is a downstream side of the conveying direction (see FIG. 4A).

Further, in order to adjust the pressing force (nip pressure or contact pressure) of primary transfer rollers 422 with respect to photoconductor drums 413, the nip pressure needs to be switched with the vertical movement of movable side plate 430 by a certain means. That is, it is preferable to have a mechanism that switches the nip pressure (contact pressure) to be strong at the nip positions for normal paper illustrated in FIG. 4A and to be weak at the nip positions for rugged paper illustrated in FIG. 4C.

Furthermore, the nip positions for normal paper illustrated in FIG. 4A and the nip positions for rugged paper illustrated in FIG. 4C differ greatly not only in the positions of primary transfer rollers 422 with respect to photoconductor drums 413 in the vertical direction (the lateral direction in FIG. 4) but also in the horizontal direction (the lateral direction in FIG. 4).

Therefore, it is insufficient in the present embodiment for movable side plates 430 to simply rotatably support primary transfer rollers 422, and it is preferable to provide a mechanism to movably hold primary transfer rollers 422 in a direction toward or away from photoconductor drums 413 (the lateral direction in FIG. 2). Furthermore, movable side plates 430, as described above, need to equip with a mechanism that can switch the nip pressure (contact pressure) according to the vertical position (movement).

Considering these many technical problems, intermediate transfer unit 42 in the present embodiment has a plurality of springs (two springs in the following example, one of which is strong and the other is weak) and a mechanism for switching the number of springs that press primary transfer rollers 422 and accordingly image carriers (intermediate transfer belt 421 or the like) along with the vertical movement of movable side plates 430, i.e., springs used as a source of contact pressure of the nip. In accordance with the present invention, such a mechanism corresponds to “contact pressure changing section” that changes the contact pressure between image carriers and the transfer rollers 422. Details will be described below.

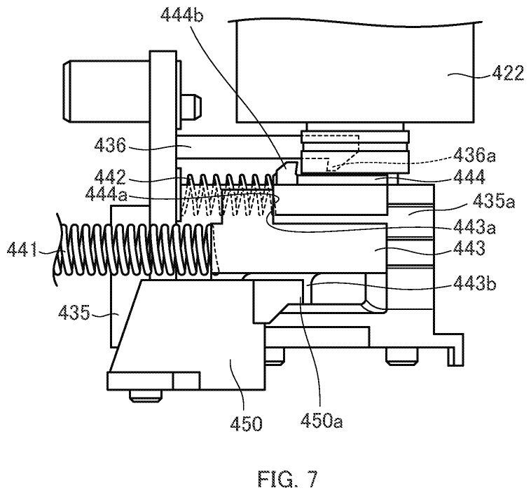

FIGS. 7, 8 and 9 are respectively a plan view, a perspective view, and a side view illustrating a configuration of the contact pressure changing section. Each of the drawings illustrates the configuration commonly provided for the four primary transfer rollers 422 (Y) to (K) described above.

Although only one end of primary transfer roller 422 is illustrated in these drawings, the configuration in FIGS. 7 to 9 is similarly provided on the other end of primary transfer roller 422 in practice.

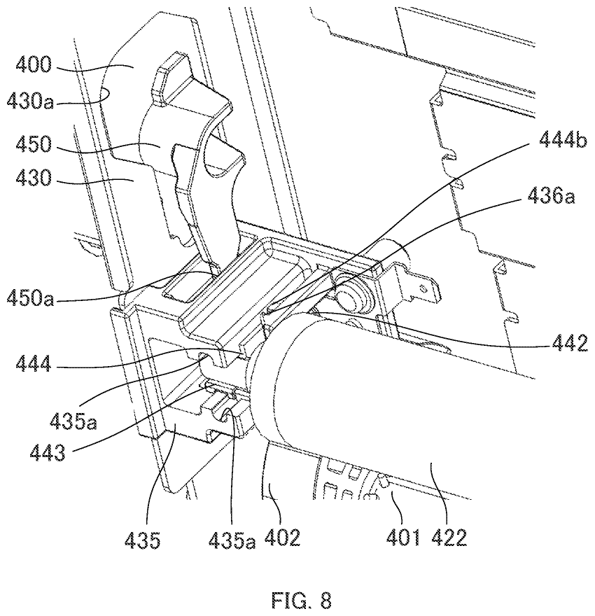

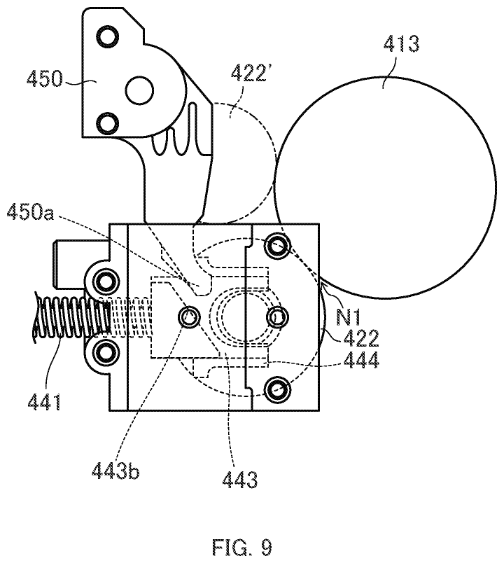

Note that intermediate transfer belt 421 and photoconductor drum 413 as image carriers are located on the right side in FIG. 7 and the front side in FIG. 8 although they are not illustrated for simplicity (refer to FIG. 9 as appropriate). Further, FIGS. 7 and 8 indicate a normal state (an initial state) illustrated in FIG. 4A. When movable side plates 430 move upward from this state, a mechanism described below causes primary transfer roller 422 to move upward and also to the left in FIG. 7, which is a rear side in FIG. 8 (see FIG. 4C).

As illustrated in FIG. 8, in the present embodiment, base member 435 is attached to movable side plate 430, and the rotary shaft of primary transfer roller 422 (hereinafter, simply referred to as “shaft”) is adapted to move along guide grooves 435a of such base member 435.

To be more specific, inside bearing 444 and outside bearing 443 hold the shaft of primary transfer roller 422 from above and below as illustrated in FIGS. 7 and 8. These inside bearing 444 and outside bearing 443 are mounted along a pair of guide grooves 435a and 435a provided at the upper and lower sections of base member 435 so that the bearings can reciprocate in a direction toward and away from image carriers (intermediate transfer belt 421 or the like).

In addition, spring 442 for pressing (energizing) inside bearing 444 is placed between base member 435 and inside bearing 444. Likewise, spring 441 for pressing (energizing) outside bearing 443 is placed between base member 435 and outside bearing 443.

In accordance with the present invention, spring 442 for pressing inside bearing 444 corresponds to “first pressing member”, and spring 441 for pressing outside bearing 443 corresponds to “second pressing member”.

That is, two springs 441 and 442 are provided in the present embodiment, and energize (press) primary transfer roller 422 (the shaft thereof) in the direction of intermediate transfer belt 421 and photoconductor drum 413 illustrated in FIG. 7 or the like (the right direction in FIG. 7). In this example, springs 441 and 442 play different roles as follows while they are both coil springs.

In the present embodiment, spring 442, which is an inner spring of the two springs (upper in FIG. 7), has a role of constantly energizing primary transfer roller 422 (the shaft thereof) through the pressing of inside bearing 444 regardless of the position of movable side plate 430, and the pressing force is weaker than spring 441 described below.

On the other hand, spring 441, which is an outer spring of the two springs (lower side in FIG. 7), has a role of switching whether or not primary transfer roller 422 (the shaft thereof) is energized (ON/OFF) in accordance with the position of movable side plate 430.

To be more specific, spring 441 constantly energizes (presses) outside bearing 443 to the right direction in FIG. 7 regardless of the position of movable side plate 430. Seeing a state illustrated in FIG. 7, a protruding section (protruding surface 443a) of outside bearing 443 makes contact with an upper side of end surface 444a of inside bearing 444.

Therefore, in the state illustrated in FIG. 7, spring 441 presses outside bearing 443 in the right direction in FIG. 7, thereby pressing inside bearing 444 and accordingly primary transfer roller 422 (the shaft thereof) in the same direction, which is a direction for pressing intermediate transfer belt 421 (not shown) and the like.

Further, in the state illustrated in FIG. 7, one end of spring 442 makes contact with base member 435, and the other end thereof makes contact with a lower side of end surface 444a of inside bearing 444, thereby energizing inside bearing 444 and accordingly primary transfer roller 422 (the shaft thereof) in the right direction in FIG. 7.

At this time, a strong contact pressure (nip pressure) is applied to primary transfer nip sections N1 as illustrated in FIG. 4A, thereby securing both the primary transfer performance and the secondary transfer performance for normal paper.

In the state of primary transfer nip sections N1 illustrated in FIG. 4A, however, a primarily transferred toner image strongly adheres to intermediate transfer belt 421, and thus the secondary transfer performance from intermediate transfer belt 421 to rugged paper is deteriorated when rugged paper is used as sheet S.

In contrast, inside bearing 444 and spring 442 move upward with primary transfer roller 422 when movable side plate 430 moves upward from the state illustrated in FIG. 7 (see 422′ in FIG. 9). Even after that, spring 442 keeps energizing inside bearing 444 and accordingly primary transfer roller 422 with a weaker pressing force than spring 441 described above.

Incidentally, as illustrated in FIG. 8, arm section 450 is placed above the shaft of primary transfer roller 422 and the like, and is fixed to the inner surface of fixed side plate 400 through groove section 430a of movable side plate 430. To be more specific, groove section 430a, which is removed by a large area (see also FIG. 5), is formed above an area to which primary transfer roller 422 is attached of movable side plate 430.

Arm section 450 described above is then provided on the inner surface of fixed side plate 400 corresponding to the area of groove section 430a. Such arm section 450 is fixed to the inner surface of fixed side plate 400 by a screw or the like, and is placed so that tip 450a of arm section 450 extends downward through groove section 430a of movable side plate 430.

Further, as referred to FIG. 9, inclined section 443b facing tip 450a of arm section 450 is protrusively formed on the opposite surface to the above-mentioned protruding surface 443a of outside bearing 443, and inclines at an angle corresponding to the inclination of the tip side of arm section 450.

According to this configuration, when movable side plate 430 moves upward from the state illustrated in FIG. 7, inclined section 443b of outside bearing 443 abuts against the tip 450a side of arm section 450, and then, outside bearing 443 moves (retracts) to the left in FIG. 9 by the inclination of inclined section 443b.

At this time, the contact (the engagement, in other words) between protruding surface 443a of outside bearing 443 and end surface 444a (upper side) of inside bearing 444, described above with reference to FIG. 7, is released, and the energizing force of spring 441 is no longer applied to inside bearing 444 and accordingly the shaft of primary transfer roller 422.

That is, when movable side plate 430 is lifted from the position illustrated in FIG. 7, primary transfer roller 422 moves to the position indicated 422′ in FIG. 9, which means that primary transfer roller 422 is lifted to the upper left direction in FIG. 9. As described above, while inside bearing 444 moves in the same direction as primary transfer roller 422 during this movement, outside bearing 443 abuts against tip 450a of arm section 450 and moves in a direction to retract from the shaft of primary transfer roller 422 based on the inclination angle of inclined section 443b. This makes outside bearing 443 no longer press inside bearing 444.

Thus, when movable side plate 430 moves upward from the state illustrated in FIG. 7, intermediate transfer belt 421 and the like no longer receive the pressing based on the strong pressing force of spring 441 (second pressing member), and the weak pressing force of spring 442 alone is applied to the shaft of inside bearing 444 and primary transfer roller 422 accordingly.

Primary transfer nip sections N1 at this time have a weaker nip pressure (contact pressure) than the normal state as illustrated in FIG. 4C. The state of primary transfer nip sections N1 illustrated in FIG. 4C weakens the adhesiveness of a primarily transferred toner image to intermediate transfer belt 421 compared to the state in FIG. 4A. This makes it possible to secure the secondary transfer performance to rugged paper from intermediate transfer belt 421 when rugged paper is used as sheet S.

As described above, the moving operation of movable side plate 430 upward from the initial state illustrated in FIG. 7 causes outside bearing 443 to move in the direction to retract from intermediate transfer belt 421 against the pressing force of spring 441, and thus the engagement of end surface 444a of inside bearing 444 and protruding surface 443a of outside bearing 443 is released. As a result, end surface 444a of inside bearing 444 is pressed by spring 442 alone having the weak pressing force, thereby pressing primary transfer nip sections N1 with a weak contact force.

To summarize, when movable side plates 430 and primary transfer nip sections N1 are located at the lower positions (the downstream side of the conveying direction), which is the normal state illustrated in FIG. 7, primary transfer rollers 422 press primary transfer nip sections N1 by the strong pressing force of two springs 441 and 442. In contrast, when movable side plates 430 and primary transfer nip sections N1 are located at the upper positions (the upstream side of the conveying direction), primary transfer rollers 422 press primary transfer nip sections N1 by the weak pressing force of spring 442 alone.

Thus, the present embodiment provides a mechanism for mechanically switching the strength of the nip pressure (contact pressure) according to the vertical movement of movable side plates 430. The mechanism yields a simple, space-saving configuration and an appropriate switching according to the type of sheet S to be used.

That is, in the present embodiment, control section 100 controls the driving of motors 80 and 81 so as to switch between the positions of the above-mentioned primary transfer nips according to the type of sheet S to be used (sheet information such as a sheet setting profile) when a print job is executed.

To be more specific, when the type of sheet S to be used is rugged paper such as embossed paper, control section 100 appropriately controls the driving of motors 80 and 81 so as to set movable side plates 430 and primary transfer rollers 422 to the upper positions, which is the state described in FIG. 4C. At this time, primary transfer nip sections N1 are pressed by spring 442 alone (a first spring) having the weak pressing force by the action of the contact pressure changing section described above.

In contrast, when the type of sheet S to be used is other than rugged paper, control section 100 appropriately controls the driving of motors 80 and 81 so as to set movable side plates 430 and primary transfer rollers 422 to the lower positions, which is the state described in FIG. 4A. At this time, primary transfer nip sections N1 are pressed by both spring 442 (a first spring) having the weak pressing force and spring 441 (a second spring) having the strong pressing force by the action of the contact pressure changing section described above.

Further, control section 100 drives and controls motor 80 so as to retract the above-described movable side plates 430 (U) and accordingly primary transfer rollers 422 (Y), 422 (Y), and 422 (C) to retracted positions when a monochrome print job is executed with K toner only.

To be more specific, control section 100 rotatably drives motor 80 so as to lower movable side plates 430 (U) from the initial state illustrated in FIG. 5 or the like, and controls the cam position (the rotational angle) of eccentric cams 402 described above so that movable side plates 430 (U) come to the lowest position.

In the present embodiment, such a simple control enables to retract movable side plates 430 (U) and the like to the retracted positions, and to release primary transfer nip sections N1 between primary transfer rollers 422 (Y), 422 (Y), and 422 (C) and corresponding photoconductor drums 413.

Hereinafter, a mechanism for achieving such a retracting operation will be described in detail. Note that such a mechanism corresponds to an additional function of the contact position changing section described above.

Referring to FIG. 8, groove section 430a of movable side plate 430 is formed wider on an upper side than a lower side.

Such a configuration of groove section 430a allows movable side plate 430 to move in the direction to retract from photoconductor drum 413 (a rear side in FIG. 8) along an outer shape of a base of arm section 450 (a base part attached to fixed side plate 400) when movable side plate 430 is lowered from the state illustrated in FIG. 8 (the initial position).

Further, as illustrated in FIG. 5, polygonal guide grooves 430b are formed above respective grooves 430a of movable side plate 430. Each of polygonal guide grooves 430b has a long connecting member 460 fixed to fixed side plates 400 passing through, and upper portions of guide grooves 430b each have an inclined side inclined at a predetermined angle.

In such a structure, the above-described inclined sides of guide grooves 430b of movable side plates 430 abut against the upper side of respective connecting members 460 when movable side plates 430 are lowered from the initial state illustrated in FIGS. 8 and 5. After the inclined sides of guide grooves 430b abut against respective connecting members 460, movable side plates 430 are led to move in accordance with the inclination angle of the inclined sides, that is, the lower left direction in FIG. 5.

This operation allows movable side plates 430 (430 (U)) as well as primary transfer rollers 422 (Y), 422 (M), and 422 (C) to be retracted from image carriers (intermediate transfer belt 421 and corresponding photoconductor drums 413).

In the present embodiment, the above-described configuration and the retracting operation thus make it possible to release primary transfer nip sections N1 between primary transfer rollers 422 (Y) to (C) and corresponding photoconductor drums 413 via intermediate transfer belt 421 at the time of monochrome printing.

In addition, the retracting operation enables to secure and/or improve a durability of primary transfer rollers 422 (Y) to (C), which are not used for monochrome printing, and intermediate transfer belt 421.

(Configuration for Improving Maintainability)

Hereinafter, a configuration for mainly improving workability and convenience of an operator at the time of maintenance of intermediate transfer unit 42, in other words, a more detailed configuration of the above-described “contact pressure changing section” will be described.

As an additional configuration of the contact pressure changing section described above, base member 435 includes arm 436 protruding in a rod shape from a position facing the rotary shaft of primary transfer roller 422 as illustrated in FIG. 7. Arm 436 is formed to extend parallel to spring 442 and inside bearing 444 described above, and a distal end of arm 436 extends to a position reaching the rotary shaft of primary transfer roller 422 as indicated by a broken line in FIG. 7. Further, the distal end of arm 436 is provided with locking section 436a protruding in a wedge shape toward inside bearing 444.

In addition, locking section 444b protruding in a wedge shape toward arm 436 is provided at a portion of inside bearing 444 facing arm 436 as illustrated in FIG. 7. In accordance with the present invention, arm 436 of base member 435 (locking section 436a in particular) and locking section 444b of inside bearing 444 correspond to “first regulating member” that regulates and prevents spring 442 and the like from coming off.

In the present embodiment having such a configuration (first regulating member), locking sections 436a and 444b engage with each other when primary transfer nip sections N1 are released and various components such as inside bearing 444 are moved to the right side in FIG. 7, thereby preventing the components from moving.

This operation makes it possible to prevent defects such as the coming-off of bearings (444 and 443), springs (442 and 441) and the like as described above when primary transfer nip sections N1 are released by retracting movable side plates 430 and the like from intermediate transfer belt 421.

In addition, when primary transfer nips N1 are released, for example, by removing intermediate transfer belt 421 or intermediate transfer unit 42 as a whole, bearings (444 and 443), springs (442 and 441), and the like can be effectively prevented from defects such as scattering. Therefore, in the present embodiment, it is possible to improve the workability and the convenience of the operator at the time of maintenance of intermediate transfer unit 42 or the like.

Further, as an additional configuration of the contact pressure changing section described above, tip 450a of arm section 450 and inclined section 443b of outside bearing 443 face each other as described above with reference to FIG. 9

In accordance with the present invention, arm section 450 of fixed side plate 400 (the tip 450a side in particular) and inclined section 443b of outside bearing 443 correspond to “second regulating member” that regulates or prevents spring 441 and the like from coming off.

That is, according to the above configuration, when primary transfer nips N1 are released, for example, by removing intermediate transfer belt 421 or intermediate transfer unit 42 as a whole from the initial state illustrated in FIG. 8, the tip 450a side of arm section 450 and inclined section 443b of outside bearing 443 abut against each other. This operation can effectively prevent defects such as outside bearing 443 and spring 441 coming off and scattering. Therefore, in the present embodiment, it is possible to improve the workability and the convenience of the operator at the time of maintenance of intermediate transfer unit 42 or the like.

As described above in detail, intermediate transfer unit 42 in image forming apparatus 1 of the present embodiment includes the contact position changing section that changes contact positions (nip positions) between the image carriers, namely intermediate transfer belt 421 and photoconductor drums 413, and primary transfer rollers 422 in the rotational direction of intermediate transfer belt 421 (the image carrier) according to the type of sheet S (the recording medium) on which an image is formed, and the contact pressure changing section that changes the primary transfer nip pressure (the contact pressure) by changing the number of pressing members (springs 441 and 442) that press photoconductor drums 413 and the like according to the contact position.

Intermediate transfer unit 42 of the present embodiment having such a configuration makes it possible to change positions of primary transfer nips N1 and the pressing force via intermediate transfer belt 421 at a time in accordance with the type of sheet S to be printed or the like. Therefore, in the present embodiment, the transfer performances, that is, the primary transfer performance to intermediate transfer belt 421, and the secondary transfer performance to sheet S can be maintained in good condition regardless of the type of sheet S.

To be more specific, intermediate transfer unit 42 makes the primary transfer nip pressure (contact pressure) lower than usual by reducing the number of springs (441 and 442), which press the shaft of primary transfer rollers 422, when movable side plates 430 holding the shafts of primary transfer rollers 422 move (are lifted) from the initial position (see FIG. 5 and the like) with respect to fixed side plates 400, which rotatably support intermediate transfer belt 421 (see FIGS. 4A and 4C).

With such a configuration, it is possible to maintain the transfer performance of an image to rugged paper in good condition even at the time of forming an image on the rugged paper, which generally is apt to have a lower transfer performance.

Although embodiments of the present invention have been described and illustrated in detail, the disclosed embodiments are made for purpose of illustration and example only and not limitation. The scope of the present invention should be interpreted by terms of the appended claims.

1. A transfer device, comprising:
a plurality of pressers capable of pressing an image carrier;
a contact position changer that changes a contact position between the image carrier and a transfer roller in a rotational direction of the image carrier according to a type of recording medium on which an image is formed; and
a contact pressure changer that changes a contact pressure between the image carrier and the transfer roller by changing a number of the plurality of pressers that press the image carrier in accordance with the contact position.

2. The transfer device according to claim 1, wherein
the plurality of pressers comprise a first presser and a second presser, wherein
the first presser presses the image carrier when the type of recording medium is rugged paper, and both the first presser and the second presser press the image carrier when the type of the recording medium is other than rugged paper in the contact pressure changer.

3. The transfer device according to claim 1, wherein the contact position changer comprises movable side plates which hold a shaft of the transfer roller and face both sides of the image carrier in a shaft direction.

4. The transfer device according to claim 3, wherein the contact position changer changes a position of the transfer roller by moving the movable side plates in accordance with a rotation angle of a cam.

5. The transfer device according to claim 4, wherein the contact position changer separates the movable side plates from the image carrier in accordance with the movement of the movable side plates.

6. The transfer device according to claim 2, wherein the contact pressure changer comprises a first regulator that regulates coming-off of the first presser.

7. The transfer device according to claim 2, wherein the contact pressure changer comprises a second regulator that regulates coming-off of the second presser.

8. The transfer device according to claim 3, wherein:
the contact pressure changer comprises a second regulator that regulates coming-off of the second presser; and
the second regulator releases the pressing against the image carrier by the second presser in accordance with a movement of the movable side plates.

9. The transfer device according to claim 5, wherein:
the movable side plates comprise first movable side plates that hold the shaft of the transfer roller transferring a black image, and second movable side plates that hold the shafts of the transfer rollers transferring an image of colors other than black; and
the contact position changer separates the second movable side plates from the image carrier at the time of monochrome printing.

10. An image forming apparatus, comprising the transfer device according to claim 1.
